(19) United States
(12) Patent Application Publication
(10) Pub. No.: US 2025/0161852 A1
(43) Pub. Date: May 22, 2025

(54) AIR FILTER AND FILTER ELEMENT THEREFOR

(71) Applicant: MANN+HUMMEL GmbH, Ludwigsburg (DE)

(72) Inventor: Daniel SCHMID, Sachsenheim (DE)

(21) Appl. No.: 19/034,682

(22) Filed: Jan. 23, 2025

Related U.S. Application Data
(63) Continuation of application No. PCT/EP2023/062977, filed on May 15, 2023.

(30) Foreign Application Priority Data
Jul. 25, 2022 (DE) 102022118516.8

(51) Int. Cl. B01D 46/00

(52) U.S. Cl. CPC B01D 46/0005; B01D 2201/0415; B01D 2271/02

(57) ABSTRACT

A filter element for an air filter has a filter medium surrounding a longitudinal axis of the filter element and an open end disc arranged at a first end of the filter medium. A seal protrudes axially away from the open end disc. The seal has a radially inwardly positioned seal surface provided with at least one local radial recess or projection at the seal surface. An air filter provided with the filter element has an openable filter housing with a housing pot and a housing cover. The housing cover has a seal collar for seal-tightly contacting the seal surface of the seal with at least one radial bulge or depression. The at least one radial bulge corresponds to the at least one local radial recess. The at least one radial depression corresponds to the at least one local radial projection.

### CROSS-REFERENCE TO RELATED APPLICATIONS

This application is a continuation application of international application No. PCT/EP2023/062977 having an international filing date of 15 May 2023 and designating the United States, the international application claiming a priority date of 25 Jul. 2022 based on prior filed German patent application No. 10 2022 118 516.8, the entire contents of the aforesaid international application and the aforesaid German patent application being incorporated herein by reference.

### BACKGROUND

The invention concerns a filter element for an air filter comprising a filter medium, surrounding a longitudinal axis in an annular shape, and an open end disc at a first end face of the filter medium, wherein a seal with a radially inwardly positioned seal surface projects away from the end disc in axial direction. The invention concerns furthermore an air filter with such a filter element and an openable filter housing with a housing pot and a housing cover, wherein the housing cover comprises a seal collar for seal-tight contact at the seal surface of the seal.

Such a filter element and such an air filter are disclosed in EP 2 742 986 B1.

Such filter elements or air filters are used, for example, for filtering combustion air for internal combustion engines or fuel cells but also as cabin air filter. In this context, for a reliable function of the air filter, it is necessary that only filter elements which match the specifications are employed. In addition, for additional functions, for example, an air-flow meter, the rotatory installation position of a filter element with rotational symmetry may be important because same-type filter elements may have same-type deviations from an ideal as a result of manufacturing conditions. For example, air-flow meters react very sensitively to such deviations; therefore, when these deviations occur always in the same manner, they can be compensated.

In the filter element known from the aforementioned EP 2 742 986 B1, a radially inwardly positioned seal surface of a seal stay can be placed against a cylindrical contact surface of a seal groove at a top housing part. The seal surface is correspondingly also cylindrically designed. The seal stay comprises furthermore a second (radially outwardly positioned) surface positioned opposite the seal surface and comprising a plurality of depressions arranged spaced apart from each other in circumferential direction. The depressions are designed such in this context that they can surround a projection with form fit when the air filter element is installed in the housing. The projection projects away from a support surface of the seal groove in the direction of the contact surface, wherein the support surface is formed at the seal groove so as to face the contact surface.

WO 2020/231769 A1 discloses a filter element with an axial seal surface which comprises a plurality of cam-shaped projections and depressions positioned therebetween in circumferential direction.

It is an object of the invention to improve the operational function of an air filter, for example, in respect to type, orientation, and sealing action of a filter element in a filter housing.

### SUMMARY

This object is solved by a filter element for an air filter, comprising:
a filter medium surrounding in an annular shape a longitudinal axis, and
an open end disc at a first end face of the filter medium;
wherein a seal with a radially inwardly positioned seal surface protrudes away from the open end disc in axial direction;
wherein the seal comprises, at the seal surface, at least one local radial recess and/or at least one local radial projection.

This object is solved furthermore by an air filter comprising:
a filter element according to the invention, and
an openable filter housing with a housing pot and a housing cover;
wherein the housing cover comprises a seal collar for seal-tight contact at the seal surface of the seal;
wherein the seal collar comprises at least one radial bulge and/or at least one radial depression which corresponds to the at least one local radial recess and/or the at least one local radial projection at the seal surface.

Further embodiments are disclosed in the respective dependent claims and the following description.

According to the invention, a filter element for an air filter is provided. The filter element may be used, for example, for filtering combustion air for internal combustion engines or fuel cells but also as a cabin air filter.

The filter element comprises a filter medium that surrounds a longitudinal axis in an annular shape. The filter medium may be folded in a star shape, for example, or wound. The filter medium may be round or oval in cross section. The filter medium may be cylindrical or conical.

Directional specifications, for example, axial or radial, relate to the longitudinal axis if nothing to the contrary is indicated.

The filter medium may be stabilized radially inwardly by a support pipe. As an alternative or in addition, the filter medium may be stabilized radially outwardly by a cage. For outward stabilization, in particular of a wound filter medium, a thread coil may also be applied to the filter element.

The filter element comprises an open end disc at a first end face of the filter medium. The open end disc closes off the filter medium at the first end face and seals the filter medium at the first end face in axial direction. The opening of the end disc enables inflow or outflow of air into or out of an interior of the filter element. The filter element may be flowed through radially from the exterior to the interior, or alternatively, may be flowed from the interior to the exterior.

A seal with a radially inwardly positioned seal surface projects away from the open end disc in axial direction. The seal continuously surrounds the opening of the end disc in circumferential direction. The seal may be described, for example, as a circumferentially extending ring. The seal surface serves for seal-tight contact at a corresponding counter contour, for example, a seal collar, of a filter housing. The seal and the end disc may be formed together as one piece. As an alternative, the seal and the end disc may be components which are separate from each other and which, for example, may be connected to each other by gluing, fusing or injection molding. The seal may have rotational symmetry, for example, in regard to rotations of about 120°.

According to the invention, the seal comprises at the seal surface at least a local radial recess and/or at least a local radial projection. When viewed in the direction of the longitudinal axis, the seal surface is thus not formed strictly in a basic shape, for example, circular shape, but comprises local deviations from the basic shape, for example, the circular shape. The at least one local radial recess or projection at the seal surface contributes to the sealing action in relation to the filter housing. The filter housing is contoured at the seal collar accordingly. Due to the deviation of the circular basic shape at the seal surface, an installation of the filter element is forced in a defined rotational orientation. In addition, it is ensured that only filter elements which are matched to the respective air filter can be used. The at least one local radial recess and/or projection extends only partially circumferentially at the seal surface.

The seal comprises at least one local axial recess at an end face. The at least one local radial recess and/or projection at the seal surface may be displaced or offset in relation to the at least one local axial recess at the end face in circumferential direction. Upon installation of the filter element in the filter housing, the alignment of the filter element can be further simplified in this way. The at least one local axial recess extends only partially circumferentially at the end face.

The seal comprises at least one local radial recess at a radially outwardly positioned guide surface. The at least one local radial recess at the guide surface may be displaced in circumferential direction in relation to the at least one local radial recess and/or projection at the seal surface. The at least one local radial recess at the guide surface may also be offset in relation to the at least one local axial recess at the end face in circumferential direction. The alignment of the filter element in relation to the filter housing can be further improved by means of the local radial recess at the guide surface of the seal. For example, a guide element of the filter housing may engage the recess at the guide surface.

The filter element furthermore may comprise a closed bottom disc at a second end face of the filter medium. The bottom disc closes off the filter medium at the second end face, which is positioned opposite the first end face, and seals it in axial direction. In case of a closed embodiment of the bottom disc, an inflow or outflow of air into or out of the interior of the filter element is additionally prevented at the second end face.

The bottom disc of the filter element may comprise an opening. Through the opening, filtered air can be guided to a secondary air outlet. The secondary air outlet may be provided at a housing pot of the filter housing. For example, the opening at the bottom disc and the secondary air outlet may be arranged eccentrically in relation to the longitudinal axis.

The bottom disc may comprise a support structure, for example, at least one support rib projecting in axial direction for support at a housing bottom of a filter housing. This improves the retention of the filter element in the filter housing.

The present invention encompasses furthermore an air filter comprising a filter element according to the invention as described above and an openable filter housing with a housing pot and a housing cover. The filter element is configured to be received in the filter housing. In the mounted state with the filter housing closed, the filter element separates a raw side from a clean side in the filter housing.

The housing cover comprises a seal collar for seal-tight contact at the seal surface of the seal. The seal collar typically protrudes into the interior of the filter housing. The seal collar comprises at least one radial bulge and/or at least one radial depression which corresponds to the at least one radial recess and/or projection at the seal surface. In the mounted state, the bulge or depression of the seal collar engages the recess or projection of the seal at the seal surface. In the region of the bulge or depression and of the recess or projection, the seal collar and the seal surface are contacting each other seal-tightly. Accordingly, the fluidic separation of the raw side from the clean side is ensured. The engagement of bulge or depression of the seal collar and recess or projection of the seal define additionally a rotatory alignment of the filter element in relation to the housing cover.

The seal collar may comprise at least one axial recess. For example, the axial recess is formed at the at least one radial bulge and/or depression. In other words, the seal collar in sections may be shorter in the axial direction than in others, wherein these shorter sections form the bulge or depression. This effects a variable sealing course in axial direction. In other words, the contact line of maximum contact pressure between the seal collar and the seal may extend up and down in the axial direction. Due to the interaction of the bulge or depression of the seal collar with the recess or projection of the seal, the sealing course, when viewed along the longitudinal axis, deviates additionally from a circular shape. The complex sealing course further ensures the use of matching filter elements in the filter housing. The axial recess may comprise a depth of at least 1.5 mm, for example at least 3 mm, and/or at most 8 mm, for example at most 6 mm.

When the seal comprises at least one axial recess at an end face, the housing cover may comprise at least one stay for engagement in the at least one axial recess. Upon installation of the filter element in the filter housing, the alignment of the filter element at the housing cover can be further simplified in this way.

When the seal comprises at least one radial recess at a radially outwardly positioned guide surface, the housing cover may comprise at least one guide element, which is spaced apart from the seal collar in radial direction, for engagement in the radial recess at the guide surface. The alignment of the filter element relative to the housing cover can be improved further in this way.

The housing cover may comprise a guide collar for contact at the outer circumference of the open end disc. In this way, the filter element can be supported in radial direction in the region of the open end disc. Vibrations thus do not have an effect on the seal-tight contact of seal and seal collar at each other.

The seal collar may be configured at a clean air outlet, for example at an outlet socket. This enables a compact configuration of the filter housing. For example, the flow path for filtered air from the clean side interior of the filter element can be shortened.

A raw air inlet may be embodied at the housing pot. The raw air inlet enables the supply of air to be filtered to the raw side positioned radially outwardly at the filter element.

The housing pot may comprise a guide ring for contact at the outer circumference of a bottom disc of the filter element. The filter element may be fixed in this way in the region of the second end disc in the radial direction in the filter housing. For mounting, the filter element may be inserted in a simple manner into the guide ring.

A recess or projection at the seal is understood presently as a region of the seal which is retracted or protrudes in relation to an adjoining contour. In case of radial recesses or projections, the seal is thus correspondingly thinner or thicker in these regions. The recesses or projections may extend in circumferential direction across at least 3 mm, for example at least 5 mm, and/or at most 20 mm, for example at most 15 mm. A depth or height of the recesses or projections in radial direction may amount to at least 1.5 mm, for example at least 3 mm, and/or at most 8 mm, for example at most 6 mm.

A radial bulge or depression at the seal collar is presently understood as a region of the seal collar which in relation to an adjoining contour protrudes radially outwardly or is retracted radially inwardly. The depression or bulge in circumferential direction and radial direction is in principle dimensioned like the corresponding recess or projection at the seal.

### BRIEF DESCRIPTION OF DRAWINGS

Further features and advantages of the present invention result from the following detailed description of embodiments of the invention, from the appended claims, as well as on the basis of the Figures of the drawings illustrating details according to the invention. The aforementioned and still further explained features can be each realized individually alone or several in any expedient combinations in variants of the invention. The features illustrated in the drawings are illustrated such that the particularities according to the invention are made clearly visible.

FIG. 1 shows a filter element according to the invention with a protruding seal at an open end disc in a schematic perspective view.

FIG. 2 shows a schematic end view of the filter element of FIG. 1.

FIG. 3 shows a housing cover of a filter housing of an air filter according to the invention in a schematic perspective view.

FIG. 4 shows a housing pot of a filter housing of an air filter according to the invention in a schematic perspective view.

FIG. 5 shows an air filter according to the invention with the filter element of FIG. 1 and a filter housing comprising the housing cover of FIG. 3 and the housing pot of FIG. 4 in a schematic longitudinal section.

FIG. 6 shows a schematic perspective view of the air filter of FIG. 5, which is illustrated in section view at the level of the seal of the filter element, wherein stays of the housing cover engage axial recesses of the seal.

### DETAILED DESCRIPTION

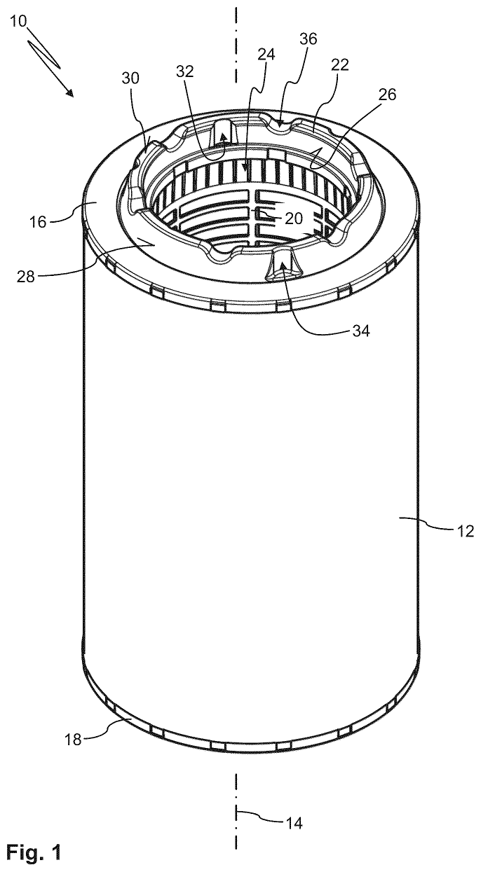

FIG. 1 shows a filter element 10. The filter element 10 comprises an annular filter medium 12 which surrounds a longitudinal axis 14. At one end, the filter medium 12 is framed at one end by an open end disc 16 and at the other end by a bottom disc 18. Radially inwardly, the filter medium 12 is supported at a grid-shaped support pipe 20.

At the end disc 16, a seal 22 protrudes in axial direction. The seal 22 surrounds a central opening 24 in the end disc 16 as a continuous circumferentially extending ring. Through the opening 24, filtered air can flow out of the interior of the filter element 10.

Radially inwardly, the seal 22 comprises a seal surface 26. Radially outwardly, the seal 22 comprises a guide surface 28. In axial direction, the seal ends at an end face 30.

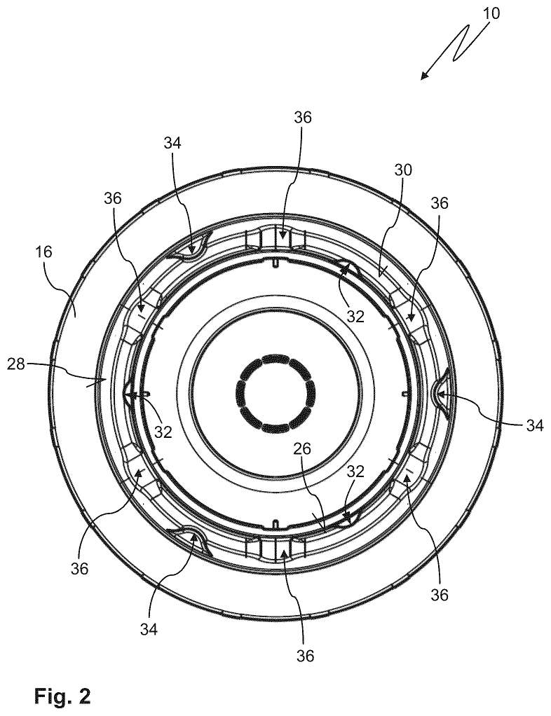

The seal surface 26, the guide surface 28, and the end face 30 are each provided with a contour, compare also FIG. 2. In other words, these surfaces each comprise geometric elements which deviate from the basic shape of the annular seal.

The seal surface 26 is provided here with three radial recesses 32. At the radial recesses 32, the seal surface 26 of the seal 22 is retracted radially outwardly in relation to the respective surroundings. As shown herein by way of example, the recesses 32 are each offset relative to each other by 120°, respectively.

The guide surface 28 is provided here likewise with three radial recesses 34. At the radial recesses 34, the guide surface 28 of the seal 22 is retracted radially inwardly in relation to the respective surroundings. As shown herein by way of example, the recesses 34 are each offset relative to each other by 120°, respectively.

The end face 30 is here formed with six axial recesses 36. At the axial recesses 36, the end face 30 of the seal 22 is retracted in relation to the respective surroundings toward the filter medium 12. As shown herein by way of example, the recesses 36 are offset relative to each other by 60°, respectively.

Here, all recesses 32, 34, 36 provided at the seal surface 26, guide surface 28 and end face 30 are offset in relation to each other, respectively. In other words, each one of the recesses 32, 34, 36 is arranged in a gap between the recesses of the other surfaces.

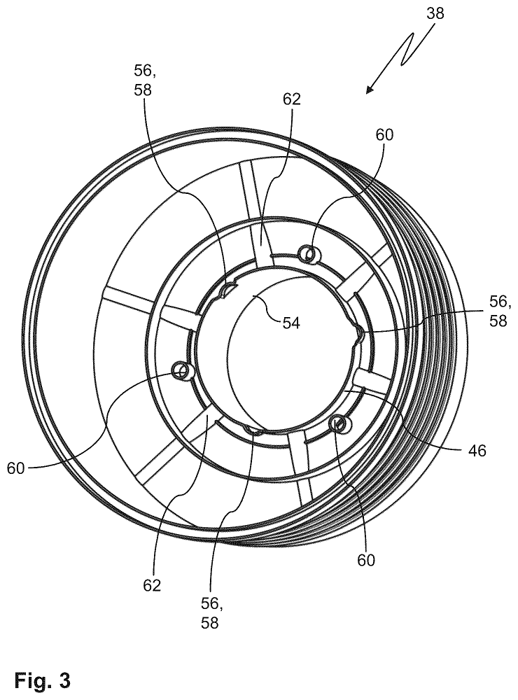

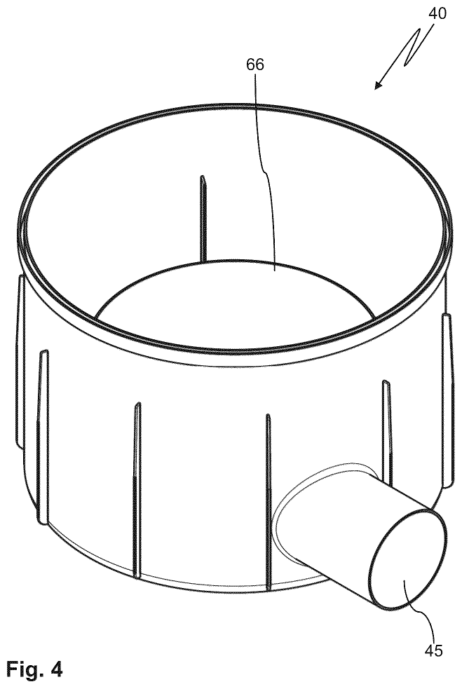

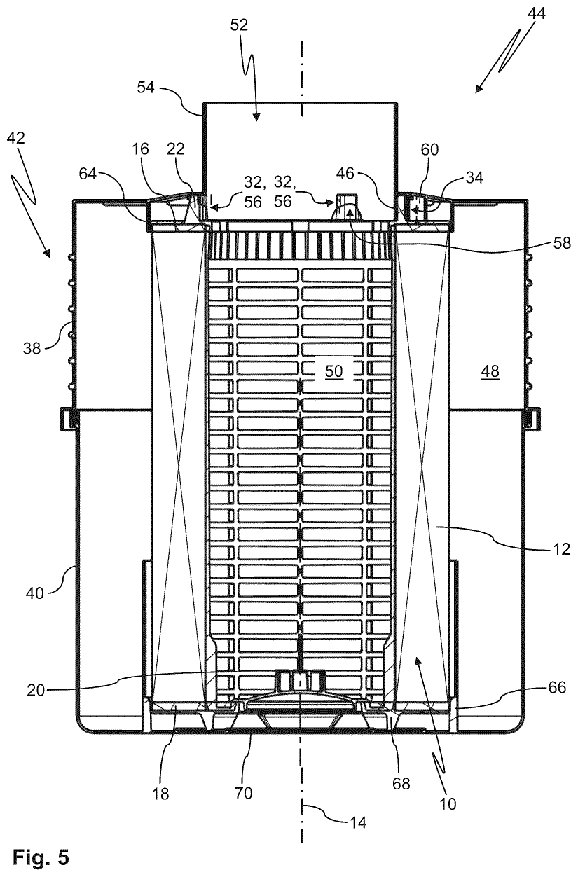

FIG. 3 shows a housing cover 38 which, together with the housing pot 40 shown in FIG. 4, forms a filter housing 42 for receiving the filter element 10, compare FIG. 5 which shows an air filter 44 with the aforementioned components. At the housing pot 40, a raw air inlet 45 may be formed.

In the mounted state, the seal 22 separates a raw side 48 from a clean side 50 by seal-tight contact at a seal collar 46 of the housing cover 38. Filtered air can be discharged from the clean side 48 through a clean air outlet 52, which is formed here with an outlet socket 54. The seal collar 46 lengthens the outlet socket 54 at the inner side of the housing cover 38.

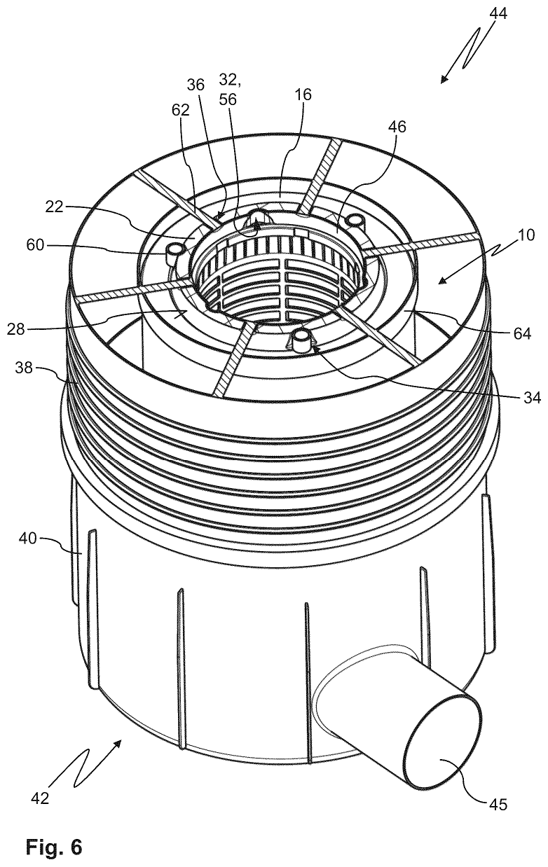

The seal collar 46 is embodied as a circumferentially extending ring. The seal collar 46 engages radially inwardly the seal 22 so that it contacts the seal surface 26. The seal collar 46 comprises radial bulges 56 corresponding to the radial recesses 32 of the seal surface 26, compare FIG. 3. The radial bulges 56 of the seal collar 46 engage radial recesses 32 of the seal surface 26, compare FIG. 5 and FIG. 6.

As shown herein, the radial bulges 56 each are provided with an axial recess 58 of the seal collar 46. In the region of the radial bulges 56, the seal collar 46 extends thus in axial direction less far into the seal 22 than in adjoining areas.

Radially outside of the seal collar 46, the housing cover 38 comprises guide elements 60 which are formed here as cylindrical pins, compare FIG. 3. In the mounted state, the guide elements 60 engage the radial recesses 34 of the guide surface 28, compare FIGS. 5 and 6.

The housing cover 38 comprises here additionally radially extending stays 62, compare FIG. 3. In the mounted state, the stays 62 engage the axial recesses 36 of the end face 30, compare FIG. 6.

In radial direction, the filter element 10 is supported by a guide collar 64 at the housing cover 38, compare FIG. 5. The guide collar 64 rests for this purpose externally at the end disc 16. The guide collar 64 surrounds the seal collar 46 concentrically.

At the bottom side, the filter element 10 is received in a guide ring 66 of the housing pot 40, compare FIG. 5. The guide ring 66 may contact externally the bottom disc 18.

The bottom disc 18 comprises one or a plurality of support ribs 68. The filter element 10 is supported in axial direction by the support rib 68 at a housing bottom 70 of the housing pot 40.

In summary, the invention concerns an annular filter element 10 for an air filter 44. An open end disc 16 is provided with a protruding seal 22. The seal 22 comprises radially inwardly a seal surface 26 which interacts seal-tightly with a seal collar 46 of a filter housing 42 which engages the seal 22. The seal surface 26 and the seal collar 46 are provided with corresponding contour shapes at which they deviate locally from their circular ring-shaped basic shape. In addition, the seal 22 may comprise, radially outwardly and at the end face, contour shapes for interaction with corresponding elements of the filter housing 42.

### LIST OF REFERENCE CHARACTERS

filter element 10
filter medium 12
longitudinal axis 14
end disc 16
bottom disc 18
support pipe 20
seal 22
opening 24
seal surface 26
guide surface 28
end face 30
radial recesses 32 of the seal surface 26
radial recesses 34 of the guide surface 28
axial recesses 36 of the end face 30
housing cover 38
housing pot 40
filter housing 42
air filter 44
raw air inlet 45
seal collar 46
raw side 48
clean side 50
clean air outlet 52
outlet socket 54
radial bulges 56 of the seal collar 46
axial recesses 58 of the seal collar 46
guide elements 60
stays 62
guide collar 64
guide ring 66
support ribs 68
housing bottom 70

What is claimed is:

1. A filter element for an air filter, the filter element comprising:
a filter medium surrounding in an annular shape a longitudinal axis of the filter element;
an open end disc arranged at a first end of the filter medium;
a seal disposed at the open end disc and protruding away from the open end disc in an axial direction;
the seal comprising a radially inwardly positioned seal surface; and
the seal comprising, at the radially inwardly positioned seal surface, at least one local radial recess and/or at least one local radial projection.

2. The filter element according to claim 1, wherein the seal further comprises at least one local axial recess at an end face of the seal.

3. The filter element according to claim 2, wherein the at least one local radial recess and/or the at least one local radial projection at the radially inwardly positioned seal surface is offset in a circumferential direction of the seal in relation to the at least one local axial recess at the end face of the seal.

4. The filter element according to claim 1, wherein the seal further comprises at least one local radial recess at a radially outwardly positioned guide surface of the seal.

5. The filter element according to claim 4, wherein the at least one local radial recess at the radially outwardly positioned guide surface of the seal is offset in a circumferential direction of the seal in relation to the at least one local radial recess and/or the at least one local projection at the radially inwardly positioned seal surface of the seal.

6. The filter element according to claim 1, further comprising a bottom disc arranged at a second end of the filter medium.

7. The filter element according to claim 6, wherein the bottom disc is closed.

8. The filter element according to claim 6, wherein the bottom disc comprises a support structure configured to support the filter element at a housing bottom of a filter housing.

9. The filter element according to claim 8, wherein the support structure comprises at least one support rib protruding in the axial direction.

10. An air filter comprising:
a filter element according to claim 1; and
an openable filter housing configured to accommodate the filter element and comprising a housing pot and a housing cover;
wherein the housing cover comprises a seal collar configured to seal-tightly contact the radially inwardly positioned seal surface of the seal of the filter element;
wherein the seal collar comprises at least one radial bulge and/or at least one radial depression, wherein the at least one radial bulge corresponds to the at least one local radial recess at the radially inwarldly positioned seal surface od the seal, and wherein the at least one radial depression corresponds to the at least one local radial projection at the radially inwardly positioned seal surface of the seal.

11. The air filter according to claim 10, wherein the seal collar comprises at least one axial recess.

12. The air filter according to claim 11, wherein the at least one axial recess of the seal collar is formed at the at least one radial bulge and/or at the at least one radial depression.

13. The air filter according to claim 10, wherein the seal of the filter element comprises at least one axial recess at an end face of the seal, and wherein the housing cover comprises at least one stay configured to engage the at least one axial recess at the end face of the seal.

14. The air filter according to claim 10, wherein the seal of the filter element comprises at least one radial recess at a radially outwardly positioned guide surface of the seal, and wherein the housing cover comprises at least one guide element spaced apart from the seal collar in a radial direction and configured to engage the at least one radial recess at the radially outwardly positioned guide surface of the seal.

15. The air filter according to claim 10, wherein the housing cover comprises a guide collar configured to contact an outer circumference of the open end disc of the filter element.

16. The air filter according to claim 10, wherein the seal collar is formed at a clean air outlet of the filter housing.

17. The air filter according to claim 16, wherein the clean air outlet of the filter housing is an outlet socket.

18. The air filter according to claim 10, wherein the housing pot comprises a guide ring configured to contact an outer circumference of a bottom disc of the filter element.
